(19) United States
(12) Patent Application Publication
(10) Pub. No.: US 2011/0292247 A1
(43) Pub. Date: Dec. 1, 2011

(54) IMAGE COMPRESSION METHOD WITH RANDOM ACCESS CAPABILITY

(75) Inventors: Mohammad Gharavi-Alkhansari, Santa Clara, CA (US); Yoichi Yagasaki, Tokyo (JP); Ali Tabatabai, Cupertino, CA (US)

(73) Assignee: SONY CORPORATION, Tokyo (JP)

(21) Appl. No.: 12/789,010

(22) Filed: May 27, 2010

(51) Int. Cl. H04N 7/26; G06K 9/36

(52) U.S. Cl. 348/231.99; 382/251; 382/244; 375/241; 375/240.12; 375/E07.026; 348/E05.024

(57) ABSTRACT

An image compression method with random access capability. The method includes intracoding of digital images. The image is partitioned into small blocks and each block is coded independently of other blocks in the image. The encoder generates a fixed and predetermined number of bits for each block. The decoding of each image block is able to be done independently of any other image block.

### FIELD OF THE INVENTION

The present invention relates to the field of image processing. More specifically, the present invention relates to image compression with random access capability.

### BACKGROUND OF THE INVENTION

Conventional image compression systems suffer from a number of problems. They are unable to exploit visual masking and other properties of the Human Visual System (HVS) which vary spatially with image content. This is because the quantization parameters used by these algorithms are typically constant over the extent of the image. As a result, images are unable to be compressed efficiently. Also, to achieve a target bit-rate or visual quality using these systems, the image must be compressed multiple times.

### SUMMARY OF THE INVENTION

An image compression method with random access capability. The method includes intracoding of digital images. The image is partitioned into small blocks and each block is coded independently of other blocks in the image. The encoder generates a fixed and predetermined number of bits for each block. The decoding of each image block is able to be done independently of any other image block.

In one aspect, a method of image compression programmed in a controller in a device comprises partitioning an image into one or more blocks, encoding a block of the one or more blocks with a plurality of quantization factor values, determining a best mode of the encoding with the plurality of quantization factor values and processing the block with the best mode of the encoding to generate a compressed data. The method further comprises computing a code length for each of the quantization factor values. Determining the best mode includes automatically rejecting a quantization factor if the quantization factor results in a bit count higher than a maximum bit count allowed. Encoding the block includes encoding the block using differential pulse code modulation encoding and pulse code modulation encoding. Differential pulse code modulation encoding includes: quantizing the block, computing a prediction value in raster scan order for each quantized sample in the block, determining a quantized residual by determining a difference between a quantized block sample and the prediction value of the quantized sample for each of the samples and outputting a first sample quantized value and a set of quantized residuals. The best mode has the most number of bits, of the original block samples, encoded losslessly. Processing the block with the best mode includes pulse code modulation encoding or differential pulse code modulation encoding which further comprises making signaling bits, entropy coding and refinement. Entropy coding includes determining for a quantized residual a number of magnitude bits, an equivalent number of preceding zeros and a sign bit. The compressed data is a fixed and predetermined size. The controller is selected from the group consisting of a programmed computer readable medium and an application-specific circuit. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

In another aspect, a method of decoding an image block programmed in a controller in a device comprises determining if the image block is encoded using differential pulse code modulation or pulse code modulation, if the image block is encoded using differential pulse code modulation, then decoding the image block using differential pulse code modulation decoding and if the image block is encoded using pulse code modulation, then decoding the image block using pulse code modulation decoding. An image block is decoded independently from other image blocks.

In another aspect, an encoder programmed in a controller in a device comprises a first differential pulse code modulation encoding with a quantization factor module for encoding a block of the one or more blocks with a plurality of quantization factor values, a code length computation module for determining a code length of an encoded block, a mode decision module for determining a best mode of the encoding with the plurality of quantization factor values, a pulse code modulation module for performing pulse code modulation encoding, if pulse code modulation is selected as the best mode and a second differential pulse code modulation encoding with a quantization factor module for encoding a block of the one or more blocks with a selected best mode quantization factor, if differential pulse code modulation is selected as the best mode. The encoder further comprises a make signaling bits module for generating bits for signaling the second differential pulse code modulation module, an entropy coding module for generating a bitstream and a refinement module for refining the bitstream. The bitstream is a fixed and predetermined size.

In another aspect, a decoder programmed in a controller in a device comprises a determining module to determine if the block is encoded using differential pulse code modulation or pulse code modulation, a differential pulse code modulation module for decoding the block using differential pulse code modulation decoding if the block is encoded using differential pulse code modulation and a pulse code modulation module for decoding the block using pulse code modulation decoding if the block is encoded using pulse code modulation.

In another aspect, a system programmed in a controller in a device comprises an encoder for partitioning an image into one or more blocks, encoding a block of the one or more blocks with a plurality of quantization factor values, determining a best mode of the encoding with the plurality of quantization factor values and processing the block with the best mode of the encoding to generate a compressed data and a decoder for: determining if the block is encoded using differential pulse code modulation or pulse code modulation, if the block is encoded using differential pulse code modulation, then decoding the block using differential pulse code modulation decoding and if the block is encoded using pulse code modulation, then decoding the block using pulse code modulation decoding.

In another aspect, a camera device comprises a video acquisition component for acquiring a video, a memory for storing an application, the application for: partitioning an image into one or more blocks, encoding a block of the one or more blocks with a plurality of quantization factor values, determining a best mode of the encoding with the plurality of quantization factor values and processing the block with the best mode of the encoding to generate a compressed data and a processing component coupled to the memory, the processing component configured for processing the application. The compressed data is a fixed and predetermined size.

### BRIEF DESCRIPTION OF THE DRAWINGS

FIG. 1 illustrates a block diagram of an encoder according to some embodiments.

FIG. 2 illustrates an exemplary VLC computation according to some embodiments.

FIG. 3 illustrates an exemplary entropy coding table according to some embodiments.

FIG. 4 illustrates a bitstream structure for the differential pulse code modulation (DPCM) modes according to some embodiments.

FIG. 5 illustrates a bitstream structure for the pulse code modulation (PCM) mode, where bits per sample (bps) is an integer number according to some embodiments.

FIG. 6 illustrates a flowchart of a method of encoding an image according to some embodiments.

FIG. 7 illustrates a flowchart of a method of decoding an image according to some embodiments.

FIG. 8 illustrates a block diagram of an exemplary computing device configured to implement the image compression with random access capability method according to some embodiments.

### DETAILED DESCRIPTION OF THE PREFERRED EMBODIMENT

In video compression there are two types of coding: intra-coding and inter-coding. Intra-coding uses information from the current frame and not relative information from other frames in the video sequence. The method described herein focuses on intra-coding, although the method is able to be used for other coding implementations. In the method, an image is partitioned into blocks, each block is coded independent from the other blocks, and for each block a fixed and predetermined number of blockBitBudget bits is generated by the encoder. Using the method described herein, a block is able to be decoded without the need to decode any other parts of the image. Each block comprises sample values of one or more color components of one part of an image. The shape of each block is typically rectangular, but any shape is possible such as square, circular, ovular or triangular.

### Encoder

The number of image samples in a block is referred to as samplesNum. For a block, on average, the encoder hence generates a sample with a specific number of bits per sample (bps) where bps=blockBitBudget/samplesNum. The value of the bps should be greater than 1, and typical values for bps are 4, 5 or 6. Other terms used herein include PCMcodeLengthTotal which is the number of bits generated if a block is coded in pulse code modulation (PCM) mode (excluding the one bit used for signaling between DPCM and PCM), PCMcodeLengthTotal is equal to blockBitBudget; DPCMcodeLengthTotal is the number of bits generated if a block is coded in a differential pulse code modulation (DPCM) mode; and depth is the bit depth of the original samples of the image, typical depth values include 8, 10 or 12, although other values are possible.

A purpose of the encoder is to take an image which has a depth bps and generate a bitstream for the image so that it has blockBitBudget bits per block. The decoder then reverses this.

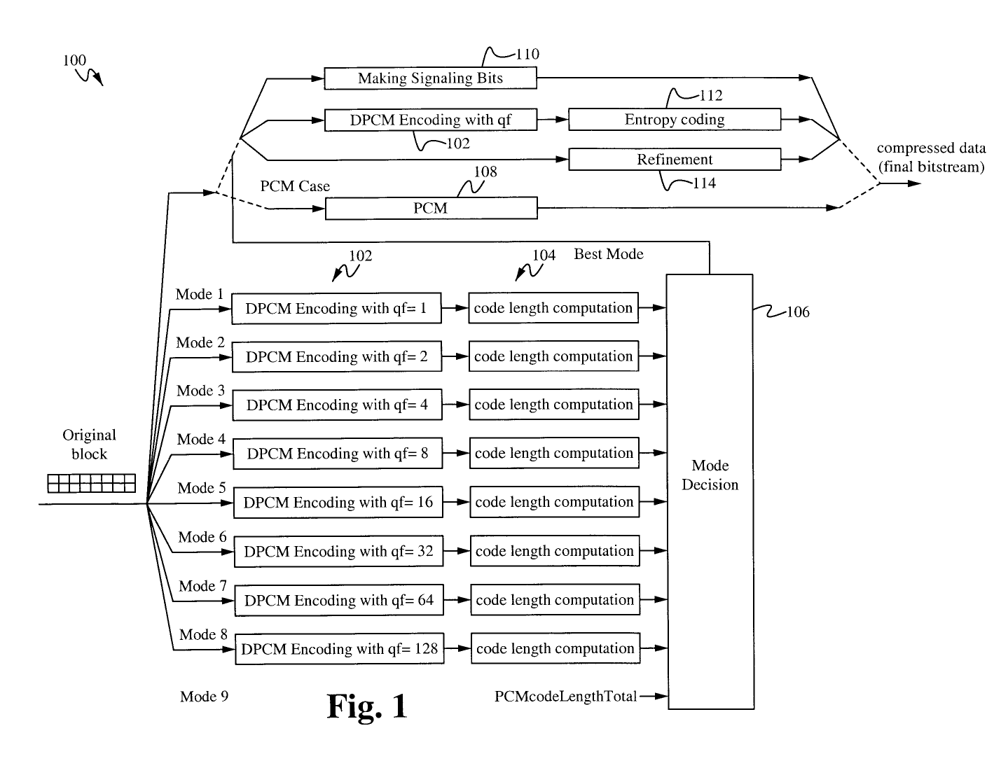

FIG. 1 illustrates a block diagram of an encoder 100 according to some embodiments. An original data block is encoded using DPCM encoding with different quantization factors such as 1, 2, 4, 8, 16, 32, 64 and 128. The code length is computed from each DPCM encoding. This code length includes all signaling bits but excludes refinement and zero pad bits (as will be explained later). If the DPCM encoding with a quantization factor results in a bit count higher than the maximum bit count allowed (blockBitBudget), then that coding is automatically rejected. For example, if the maximum bit count is 160 and the encoding for a quantization factor results in a bit count of 170, that encoding is rejected. The data block is also encoded using PCM. Of the remaining encodings, a best mode is selected from the different DPCM encodings and PCM encoding. The best mode corresponds to the highest reconstructed quality at the decoder, as represented by the number of bits per block samples that are coded losslessly. If a DPCM mode is selected, further steps are taken such as making signaling bits, DPCM encoding with qf followed by entropy coding, and refinement. If a PCM mode is selected, a PCM process occurs. The result is a compressed video bitstream. In some embodiments, the encoder 100 includes one or more modules to perform DPCM encoding with qf 102, code length computation 104, mode decision 106, PCM 108, make signaling bits 110, entropy coding 112 and refinement 114. The modules are able to be implemented in hardware, software, firmware or any combination thereof.

DPCM Encoding with a qf Module

For DPCM encoding, a block is uniformly quantized with a quantization step size (also referred to as a quantization factor) qf, where qf is a power of 2: qf=2^{qn}. The sample values of the block after quantization are referred to as a quantized block or quantized samples. Quantization essentially removes the least significant bits. For example, if there are 10 bits and qn is 4, then only the 6 most significant bits are used.

For each of the samples in the quantized block, except for the first sample of each color component, in raster scan order, a prediction value is computed based on one or more other previous quantized sample values in the quantized block. The prediction value is able to be obtained using planar prediction a+b−c where a is an adjacent pixel (e.g. left pixel), b is an adjacent pixel (e.g. above pixel), and c is a diagonally adjacent pixel; JPEG-LS prediction or any other type of prediction that does not require access to sample values outside the block being coded. The difference between the sample in the quantized block and its prediction is computed and is referred to as the quantized residual. The output of DPCM encoding with qf includes a quantized value of the first sample for each component and the quantized residuals for the remaining samples. The quantized values and the magnitude of quantized residuals are each depth minus qn bits. The quantized residuals also have one extra bit for sign.

### Code Length Computation Module

For each of the outputs of the DPCM encoding with qf module, a value is generated, denoted by DPCMcodeLengthTotal. DPCMcodeLengthTotal is the sum of the lengths of the codes that the entropy coding module and the make signaling bits module would generate if the block is coded using the DPCM mode. DPCMcodeLengthTotal is able to be computed without generating the bitstream.

### Mode Decision Module

The mode decision module rejects all DPCM modes for which DPCMcodeLengthTotal is greater than blockBitBudget. For the remaining modes, the mode decision module computes the bit coverage for each of the modes. For any given mode, bit coverage is the number of bits of all original samples in the block that are coded losslessly in that mode. Bit coverage is the measure of coding quality used for mode decision. For the PCM mode, the bit coverage is able to be set to always equal blockBitBudget−1. For the DPCM modes, the bit coverage is variable and depends on qn and the block sample values. The mode decision module selects the mode whose bit coverage is the largest (e.g. best mode). The mode number of the best mode is able to be the output of the mode decision module.

### PCM Module

The PCM module is used for generating a bitstream only if the best mode is the PCM mode. The PCM module generates a bitstream. The first bit of the bitstream is ‘0’ indicating the PCM mode. Let n=floor ((blockBitBudget−1)/samplesNum), where floor(x) represents the largest integer that is less than or equal to x. Also, let f=(n+1)*samplesNum−(blockBitBudget−1). Then, f samples in the block (for example, the first f samples in raster scan order) are quantized with the quantization number qn=depth−n, and the rest of the samples are quantized with qn=depth−n−1. The bits of the quantized values are then put in the bitstream without any change. When bps is an integer, this simplifies to: The rest of the bits. The rest of the bits are generated as follows. The first sample in the block is uniformly quantized with the quantization factor qn=(depth−bps+1). The value has bps−1 bits in its binary representation. The rest of the samples in the block are uniformly quantized with quantization factor qn=depth−bps. These values each have bps bits in their binary representation. The bits of the quantized samples are put in the bitstream without any change. The PCM module generates exactly blockBitBudget bits.

### Make Signaling Bits Module

The make signaling bits module generates m+2 bits which are then used for signaling a particular DPCM module and the value of allZeroFlag when the best mode is a DPCM mode. The first bit is a ‘1’ which signals that the best mode is a DPCM mode and not a PCM mode. It is understood that although ‘0’ and ‘1’ are specified as PCM and DPCM modes, respectively, the inverse is also able to be used. The next m bits represent the DPCM mode number. The next bit is an ‘allZeroFlag’ bit and is set to 0, if at least one of the quantized residuals is non-zero, and 1, if all of the quantized results are zero.

### Entropy Encoding Module

The entropy encoding module generates a bitstream. The binary representations of the quantized first samples of each color component (depth-qn bits per sample) are put in the bitstream. If allZeroFlag is ‘1’, then no other bits are put in the bitstream. Otherwise, for the rest of the sample in a block, variable length code (VLC) bits are generated by applying mapping and exponential Golomb coding, as described herein. For any given quantized residual value, the entropy coder computes the VLC by:

1. Counting the total number of bits needed for representing the magnitude of the quantized residual (ignoring 0's on the left of the most significant ‘1’). This gives the value K for the quantized residual.

2. Writing K zeros into the bitstream.

3. Writing the K magnitude bits.

4. Writing the sign bit: 0 for negative and 1 for zero or positive.

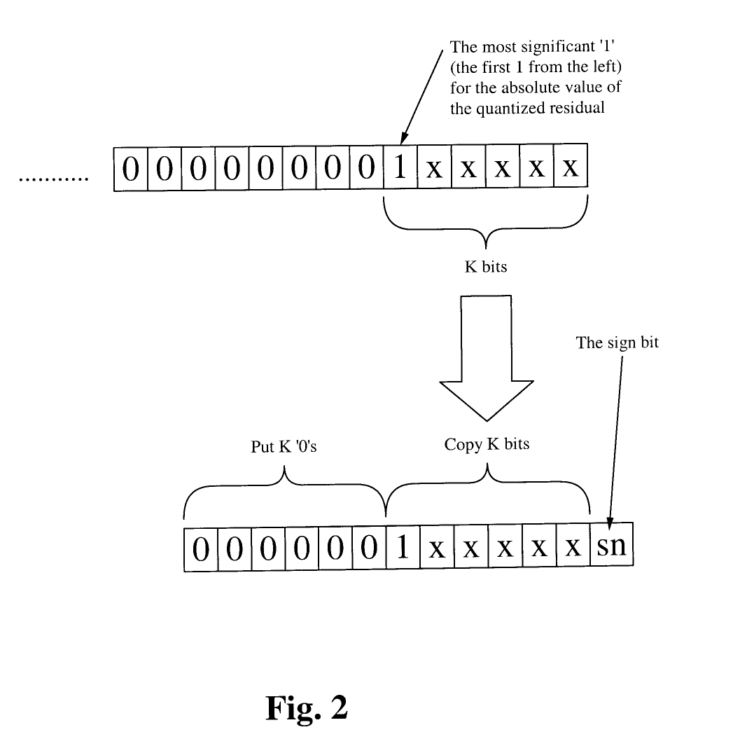

FIG. 2 illustrates an exemplary VLC computation according to some embodiments.

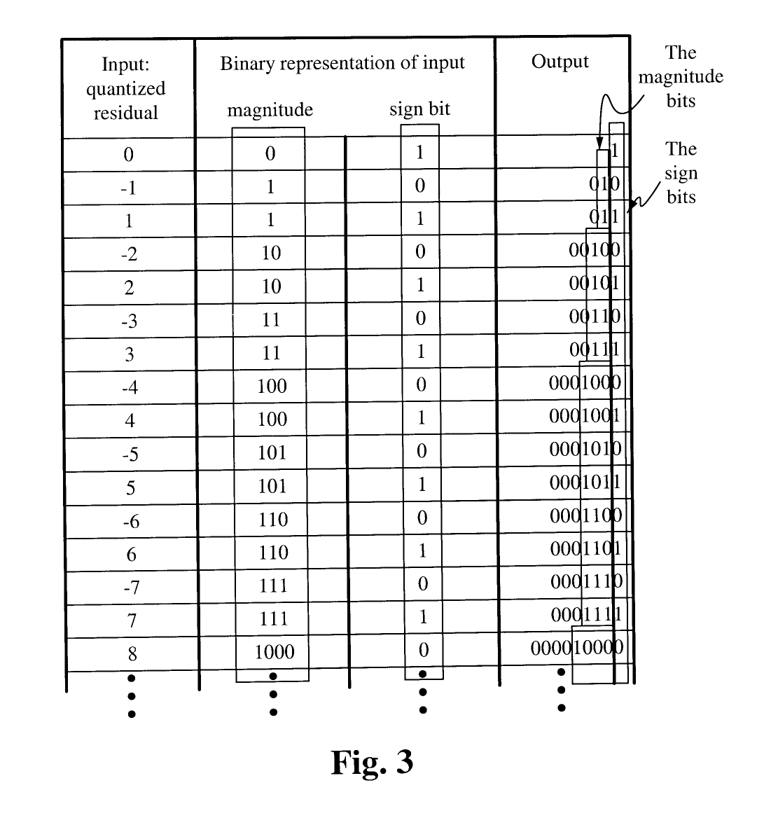

FIG. 3 illustrates an exemplary entropy coding table according to some embodiments. As shown in the table, the leftmost column is a quantized residual input. The middle columns are the binary representation of the input, the magnitude and the sign bit where the sign bit is 0 for negative and 1 for positive and zero. The output includes the K zeros before K magnitude bits and a sign bit at the end.

### Refinement Module

The refinement module first generates a bitstream including min((blockBitBudget−DPCMcodeLengthTotal), qn*samplesNum) bits, where the values of DPCMcodeLengthTotal and qn are those of the best mode. The bits are the bits of original samples, starting from the most significant bits that are not coded by the DPCM module, down to the least significant bit of each sample. Second, if (blockBitBudget−DPCMcodeLength) is larger than (qn*samplesNum), then this means that the whole block is coded losslessly with less than blockBitBudget bits. In this case, (blockBitBudget−DPCMcodeLength−qn*samplesNum) zeros are put in the bitstream, as zero pad bits, to make the total number of bits generated by the encoder equal to blockBitBudget.

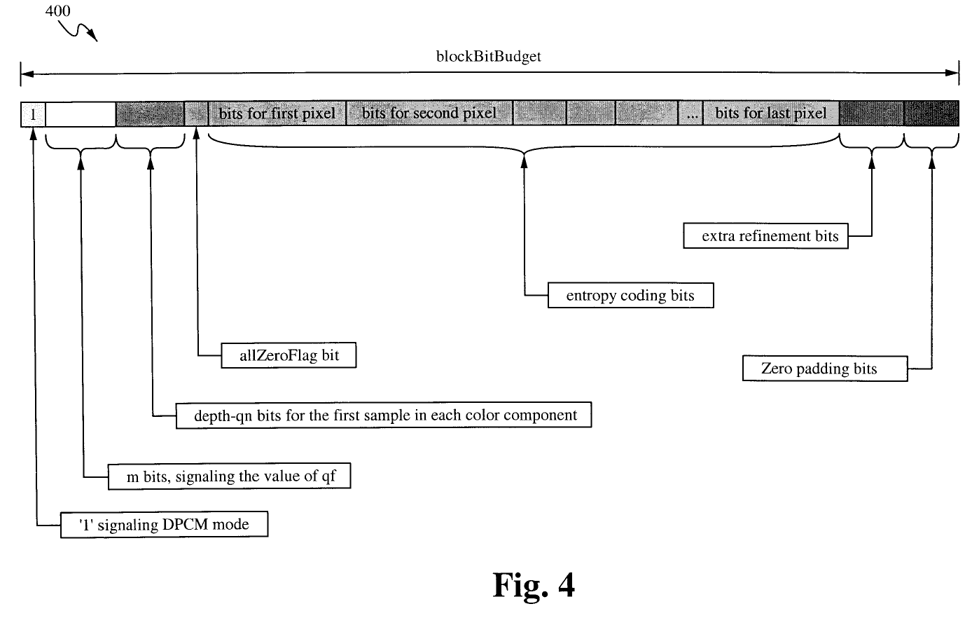

FIG. 4 illustrates a bitstream structure 400 for the DPCM modes according to some embodiments. The bitstream structure 400 has a length of blockBitBudget. A first bit (also referred to as a most significant bit) is a ‘1’ to indicate DPCM mode. Then, m bits are used to indicate the value of qf. Following are depth minus qn bits for the first sample in each color component. An allZeroFlag bit is next. For each of the remaining samples of the block, the bits generated by the entropy coding module then follow. If the total number of bits at this point are less than the block bit budget, extra refinement bits are added to further improve the accuracy of coding. Finally, zero padding bits are appended at the end if the block, after sending refinement bits, is coded losslessly.

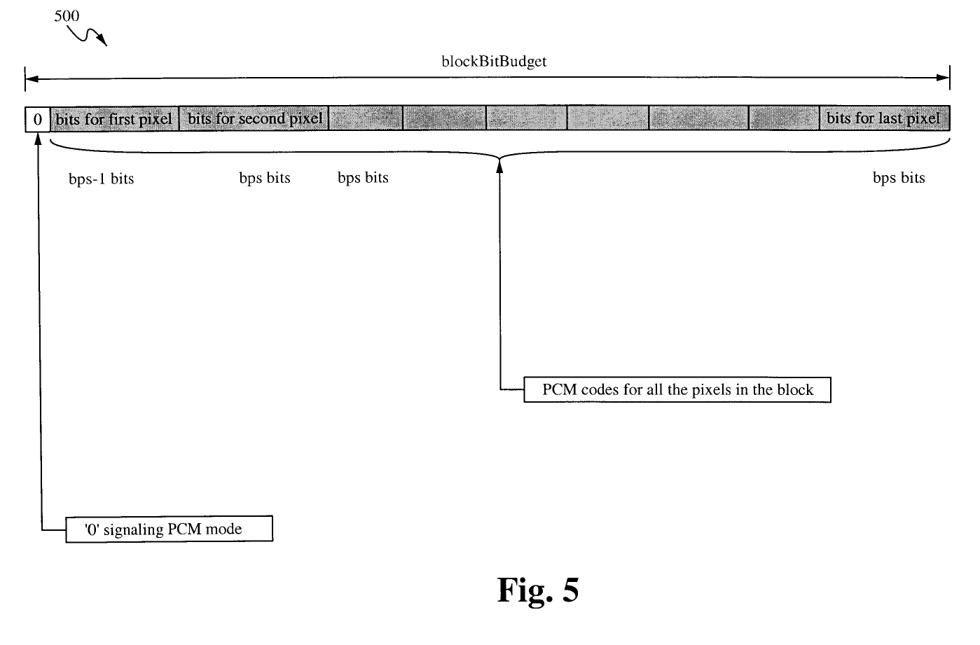

FIG. 5 illustrates a bitstream structure 500 for the PCM mode according to some embodiments. The bitstream structure 500 has a length of blockBitBudget. A first bit (also referred to as a most significant bit) is a ‘0’ to indicate PCM mode. Then, for the remaining pixels, PCM codes for all of the pixels in the block are included.

### Decoder

The first bit of the bitstream is read. If the bit is ‘0’, then the decoder applies PCM decoding. If the bit is ‘1’, then the decoder applies DPCM decoding.

### PCM Decoding

Using the notation described in the PCM Module for encoding (above), for each of the first f samples in the block, n bits are read from the bitstream, and put as the n most significant bits of the reconstructed sample at the decoder. For each of the rest of the samples in the block, n+1 bits are read from the bitstream, and put as the n+1 most significant bits of that reconstructed sample. If bps is an integer, this process is simplified to: for the first sample, bps−1 bits are read from the bitstream. The bits are put as the bps−1 most significant bits of the first sample in the block. For each of the remaining samplesNum−1 samples in the block, bps bits are read from the bitstream and the bits are put as the bps most significant bits of the sample. The next most significant bit of the samples that is not set in the above process is set to ‘1’. The rest of the bits of the depth bit samples are set to ‘0’.

### DPCM Decoding

The next m bits of the bitstream are read. Using these m bits, the of value used for quantization is decoded. The next bit of the bitstream is read. The bit represents the allZeroFlag. The depth minus qn most significant bits of the first samples of each color component are read from the bitstream, and are put as the most significant bits of those samples. If allZeroFlag=0, then for the rest of the samples, the entropy coded VLCs are read and decoded to generate the quantized residuals. For each samples, a prediction of the quantized sample is computed that same way that it is computed at the encoder, based on the previously encoded/decoded quantized samples. Then, the quantized residuals are added to the prediction values (of the quantized samples) to generate the quantized samples. These quantized samples are put as the depth minus qn most significant bits of the rest of the samples. Otherwise (e.g. if allZeroFlag=1), the depth minus qn most significant bits of the rest of the samples are set to 0. If qn>0, for the remaining qn bits of each sample, the refinement bits (if any) are read and put in place in exactly the same order that they were put in the bitstream by the encoder. Zero pad bits (if any) are ignored by the decoder. For the remaining bits of each sample (if any), the most significant bit is set to 1, and the rest of the bits are set to 0.

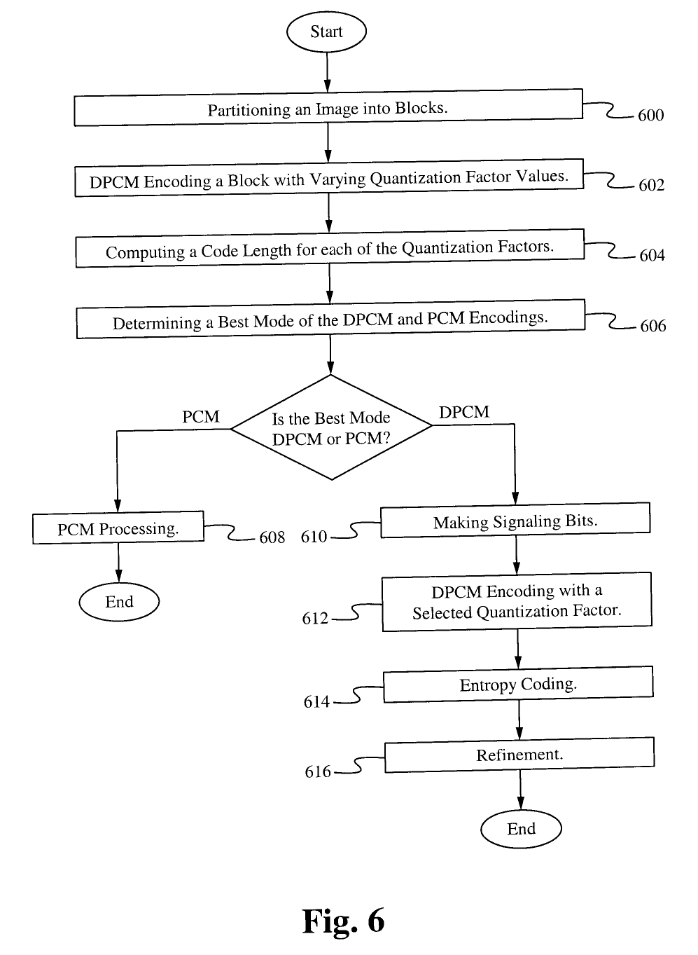

FIG. 6 illustrates a flowchart of a method of encoding an image according to some embodiments. In the step 600, the image is partitioned into blocks. In the step 602, a block is DPCM encoded with different quantization factor values. In the step 604, a code length for each of the quantization factors is computed. In the step 606, a decision is made as to which is the best mode. The best mode is selected from the DPCM encoding with the different quantization factors and a PCM encoding. As described herein, the best mode is the block that is the most lossless, as measured by its bit coverage. Bit coverage includes only the number of all the bits that are coded through entropy coding and refinement in the DPCM, or by explicitly putting the bits in the bitstream in PCM. For example, the number of lossless bits is counted and the mode with the most lossless bits equals the best mode. Depending on the mode decision in the step 606, the next step is either the DPCM case or the PCM case. If the PCM is chosen, then PCM processing occurs in the step 608. If the DPCM is chosen, then the process of making signaling bits occurs in the step 610. In the step 612, DPCM encoding with qf occurs. In some embodiments, if DPCM encoding with qf occurs in the step 602, then, the step is not repeated. In some embodiments, the steps 602 and 612 are different, so that the step 612 does occur. For example, in some embodiments, in the step 602, a bitstream is not generated but in the step 612, the bitstream is generated. Or, in the step 602, encoding does not occur, rather bits are counted, and in the step 612, encoding does occur. Then, entropy coding takes place in the step 614. Refinement occurs in the step 616. The final bitstream is the compressed data. The order of the steps is able to be changed and in some embodiments, some steps are able to be skipped.

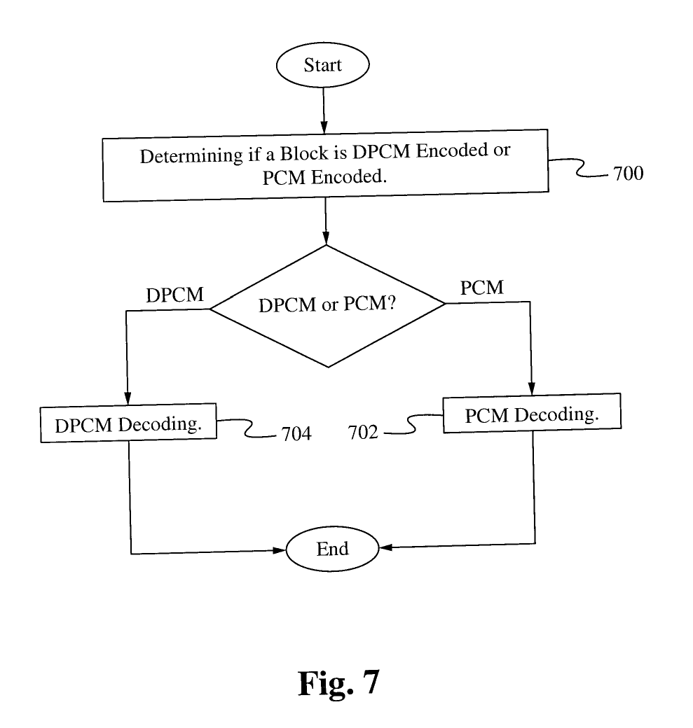

FIG. 7 illustrates a flowchart of a method of decoding an image according to some embodiments. In the step 700, it is determined if the block is encoded using DPCM encoding or PCM encoding. If the PCM encoding is used, then PCM decoding is used in the step 702. PCM decoding has been described herein. If the DPCM encoding is used, then DPCM decoding is used in the step 704.

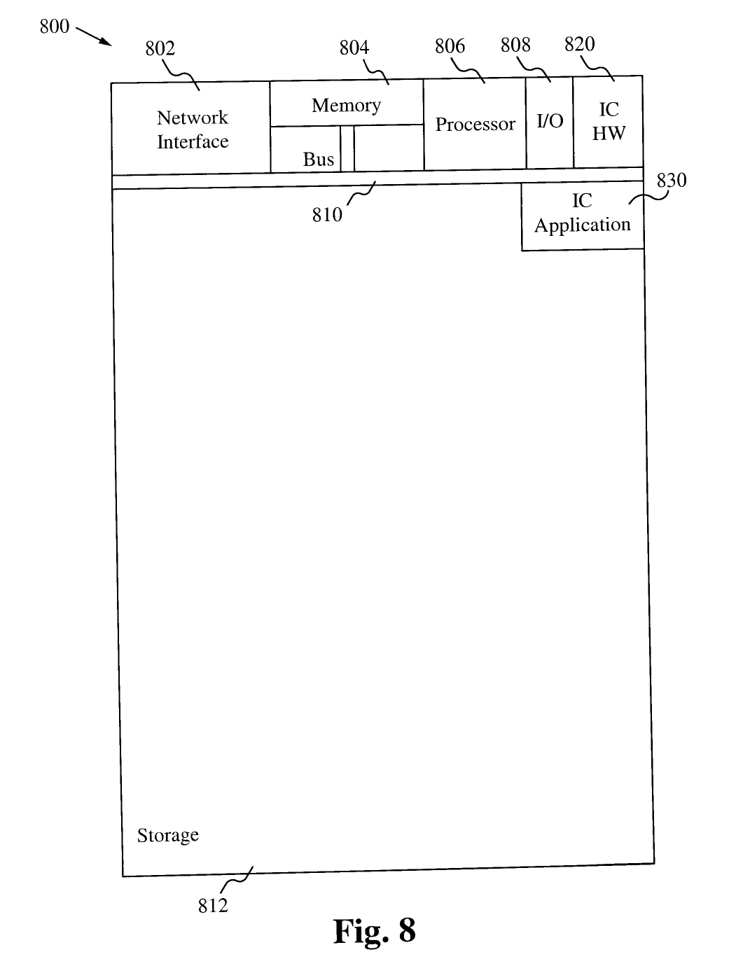

FIG. 8 illustrates a block diagram of an exemplary computing device 800 configured to implement the image compression with random access capability method according to some embodiments. The computing device 800 is able to be used to acquire, store, compute, communicate and/or display information such as images and videos. For example, a computing device 800 is able to acquire and store an image. The image compression method is able to be used when acquiring or viewing an image on the device 800. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, display, printer, modem, touchscreen, button interface and other devices. Image compression application(s) 830 used to perform the image compression method are likely to be stored in the storage device 812 and memory 804 and processed as applications are typically processed. More or less components shown in FIG. 8 are able to be included in the computing device 800. In some embodiments, image compression hardware 820 is included. Although the computing device 800 in FIG. 8 includes applications 830 and hardware 820 for image compression, the image compression method is able to be implemented on a computing device in hardware, firmware, software or any combination thereof. For example, in some embodiments, the image compression applications 830 are programmed in a memory and executed using a processor. In another example, in some embodiments, the image compression hardware 820 is programmed hardware logic including gates specifically designed to implement the image compression method.

In some embodiments, the image compression application(s) 830 include several applications and/or modules. As described herein, the modules include DPCM encoding with qf, code length computation, mode decision, PCM, make signaling bits, entropy coding and refinement. In some embodiments, a second DPCM encoding with qf module is utilized, where the first one is used to help determine a best mode, and the second one is used to perform the encoding. In some embodiments, a separate DPCM encoding module exists for each quantization factor. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a television, a home entertainment system or any other suitable computing device.

To utilize the image compression method, a user acquires a video/image such as on a digital camcorder, and while or after the video is acquired, the image compression method automatically compresses each image of the video, so that the video is compressed appropriately to maintain a high quality video. The image compression method occurs automatically without user involvement. Similarly, when a decoder is decoding the video, the decoder automatically decodes the video so that it display appropriately.

In operation, the image compression method described herein provides image compression with a low hardware cost (e.g. not many logic gates are needed) in some embodiments, low complexity, low delay, very high visual quality (e.g. visually lossless) and does not depend on other blocks for decoding (e.g. decode any block since fixed block size). The image compression method is able to be used in any implementation including, but not limited to, wireless high definition (Wireless HD).

The image compression method described herein is able to be used with videos and/or image.

Some Embodiments of an Image Compression Method with Random Access Capability
1. A method of image compression programmed in a controller in a device comprising:
   a. partitioning an image into one or more blocks;
   b. encoding a block of the one or more blocks with a plurality of quantization factor values;
   c. determining a best mode of the encoding with the plurality of quantization factor values; and
   d. processing the block with the best mode of the encoding to generate a compressed data.
2. The method of clause 1 further comprising computing a code length for each of the quantization factor values.
3. The method of clause 1 wherein determining the best mode includes automatically rejecting a quantization factor if the quantization factor results in a bit count higher than a maximum bit count allowed.
4. The method of clause 1 wherein encoding the block includes encoding the block using differential pulse code modulation encoding and pulse code modulation encoding.
5. The method of clause 4 wherein differential pulse code modulation encoding includes:
   a. quantizing the block;
   b. computing a prediction value in raster scan order for each quantized sample in the block;
   c. determining a quantized residual by determining a difference between a quantized block sample and the prediction value of the quantized sample for each of the samples; and
   d. outputting a first sample quantized value and a set of quantized residuals.
6. The method of clause 1 wherein the best mode has the most bits encoded losslessly.
7. The method of clause 1 wherein processing the block with the best mode includes pulse code modulation encoding or differential pulse code modulation encoding which further comprises making signaling bits, entropy coding and refinement.
8. The method of clause 7 wherein entropy coding includes determining for a quantized residual a number of magnitude bits, an equivalent number of preceding zeros and a sign bit.
9. The method of clause 1 wherein the compressed data is a fixed and predetermined size.
10. The method of clause 1 wherein the controller is selected from the group consisting of a programmed computer readable medium and an application-specific circuit.
11. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.
12. A method of decoding an image block programmed in a controller in a device comprising:
   a. determining if the image block is encoded using differential pulse code modulation or pulse code modulation;
   b. if the image block is encoded using differential pulse code modulation, then decoding the image block using differential pulse code modulation decoding; and
   c. if the image block is encoded using pulse code modulation, then decoding the image block using pulse code modulation decoding.
13. The method of clause 12 wherein the image block is decoded independently from other image blocks.
14. An encoder programmed in a controller in a device comprising:
   a. a first differential pulse code modulation encoding with a quantization factor module for encoding a block of the one or more blocks with a plurality of quantization factor values;
   b. a code length computation module for determining a code length of an encoded block;
   c. a mode decision module for determining a best mode of the encoding with the plurality of quantization factor values;
   d. a pulse code modulation module for performing pulse code modulation encoding, if pulse code modulation is selected as the best mode; and
   e. a second differential pulse code modulation encoding with a quantization factor module for encoding a block of the one or more blocks with a selected best mode quantization factor, if differential pulse code modulation is selected as the best mode.
15. The encoder of clause 14 further comprising:
   a. a make signaling bits module for generating bits for signaling the second differential pulse code modulation module;
   b. an entropy coding module for generating a bitstream; and
   c. a refinement module for refining the bitstream.
16. The encoder of clause 15 wherein the bitstream is a fixed and predetermined size.
17. A decoder programmed in a controller in a device comprising:
   a. a determining module to determine if the block is encoded using differential pulse code modulation or pulse code modulation;
   b. a differential pulse code modulation module for decoding the block using differential pulse code modulation decoding if the block is encoded using differential pulse code modulation; and
   c. a pulse code modulation module for decoding the block using pulse code modulation decoding if the block is encoded using pulse code modulation.
18. A system programmed in a controller in a device comprising:
   a. an encoder for:
      i. partitioning an image into one or more blocks;
      ii. encoding a block of the one or more blocks with a plurality of quantization factor values;
      iii. determining a best mode of the encoding with the plurality of quantization factor values; and
      iv. processing the block with the best mode of the encoding to generate a compressed data; and
   b. a decoder for:
      i. determining if the block is encoded using differential pulse code modulation or pulse code modulation;
      ii. if the block is encoded using differential pulse code modulation, then decoding the block using differential pulse code modulation decoding; and
      iii. if the block is encoded using pulse code modulation, then decoding the block using pulse code modulation decoding.
19. A camera device comprising:
   a. a video acquisition component for acquiring a video;
   b. a memory for storing an application, the application for:
      i. partitioning an image into one or more blocks;
      ii. encoding a block of the one or more blocks with a plurality of quantization factor values;
      iii. determining a best mode of the encoding with the plurality of quantization factor values; and
      iv. processing the block with the best mode of the encoding to generate a compressed data; and
   c. a processing component coupled to the memory, the processing component configured for processing the application.
20. The camera of clause 19 wherein the compressed data is a fixed and predetermined size.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of image compression programmed in a controller in a device comprising:
a. partitioning an image into one or more blocks;
b. encoding a block of the one or more blocks with a plurality of quantization factor values;
c. determining a best mode of the encoding with the plurality of quantization factor values; and
d. processing the block with the best mode of the encoding to generate a compressed data.

2. The method of claim 1 further comprising computing a code length for each of the quantization factor values.

3. The method of claim 1 wherein determining the best mode includes automatically rejecting a quantization factor if the quantization factor results in a bit count higher than a maximum bit count allowed.

4. The method of claim 1 wherein encoding the block includes encoding the block using differential pulse code modulation encoding and pulse code modulation encoding.

5. The method of claim 4 wherein differential pulse code modulation encoding includes:
a. quantizing the block;
b. computing a prediction value in raster scan order for each quantized sample in the block;
c. determining a quantized residual by determining a difference between a quantized block sample and the prediction value of the quantized sample for each of the samples; and
d. outputting a first sample quantized value and a set of quantized residuals.

6. The method of claim 1 wherein the best mode has the most bits encoded losslessly.

7. The method of claim 1 wherein processing the block with the best mode includes pulse code modulation encoding or differential pulse code modulation encoding which further comprises making signaling bits, entropy coding and refinement.

8. The method of claim 7 wherein entropy coding includes determining for a quantized residual a number of magnitude bits, an equivalent number of preceding zeros and a sign bit.

9. The method of claim 1 wherein the compressed data is a fixed and predetermined size.

10. The method of claim 1 wherein the controller is selected from the group consisting of a programmed computer readable medium and an application-specific circuit.

11. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television and a home entertainment system.

12. A method of decoding an image block programmed in a controller in a device comprising:
a. determining if the image block is encoded using differential pulse code modulation or pulse code modulation;
b. if the image block is encoded using differential pulse code modulation, then decoding the image block using differential pulse code modulation decoding; and
c. if the image block is encoded using pulse code modulation, then decoding the image block using pulse code modulation decoding.

13. The method of claim 12 wherein the image block is decoded independently from other image blocks.

14. An encoder programmed in a controller in a device comprising:
a. a first differential pulse code modulation encoding with a quantization factor module for encoding a block of the one or more blocks with a plurality of quantization factor values;
b. a code length computation module for determining a code length of an encoded block;
c. a mode decision module for determining a best mode of the encoding with the plurality of quantization factor values;
d. a pulse code modulation module for performing pulse code modulation encoding, if pulse code modulation is selected as the best mode; and
e. a second differential pulse code modulation encoding with a quantization factor module for encoding a block of the one or more blocks with a selected best mode quantization factor, if differential pulse code modulation is selected as the best mode.

15. The encoder of claim 14 further comprising:
a. a make signaling bits module for generating bits for signaling the second differential pulse code modulation module;
b. an entropy coding module for generating a bitstream; and
c. a refinement module for refining the bitstream.

16. The encoder of claim 15 wherein the bitstream is a fixed and predetermined size.

17. A decoder programmed in a controller in a device comprising:
a. a determining module to determine if the block is encoded using differential pulse code modulation or pulse code modulation;
b. a differential pulse code modulation module for decoding the block using differential pulse code modulation decoding if the block is encoded using differential pulse code modulation; and
c. a pulse code modulation module for decoding the block using pulse code modulation decoding if the block is encoded using pulse code modulation.

18. A system programmed in a controller in a device comprising:
a. an encoder for:
i. partitioning an image into one or more blocks;
ii. encoding a block of the one or more blocks with a plurality of quantization factor values;
iii. determining a best mode of the encoding with the plurality of quantization factor values; and
iv. processing the block with the best mode of the encoding to generate a compressed data; and
b. a decoder for:
i. determining if the block is encoded using differential pulse code modulation or pulse code modulation;
ii. if the block is encoded using differential pulse code modulation, then decoding the block using differential pulse code modulation decoding; and
iii. if the block is encoded using pulse code modulation, then decoding the block using pulse code modulation decoding.

19. A camera device comprising:
a. a video acquisition component for acquiring a video;
b. a memory for storing an application, the application for:
i. partitioning an image into one or more blocks;
ii. encoding a block of the one or more blocks with a plurality of quantization factor values;
iii. determining a best mode of the encoding with the plurality of quantization factor values; and
iv. processing the block with the best mode of the encoding to generate a compressed data; and
c. a processing component coupled to the memory, the processing component configured for processing the application.

20. The camera of claim 19 wherein the compressed data is a fixed and predetermined size.
